(19) United States
(12) Patent Application Publication
(10) Pub. No.: US 2022/0314800 A1
(43) Pub. Date: Oct. 6, 2022

(54) SYSTEM AND METHOD FOR SOCIAL MEDIA CONTROL IN A VEHICLE COMPUTER SYSTEM

(71) Applicant: DENSO International America, Inc., Southfield, MI (US)

(72) Inventors: Yu ZHANG, Farmington Hills, MI (US); Brittany SCHOENOW, Merrill, MI (US); Bilal ALASRY, Dearborn, MI (US); Doua VANG, Davisburg, MI (US); Vikas UPMANUE, Novi, MI (US); Te-Ping KANG, Ann Arbor, MI (US)

(21) Appl. No.: 17/218,764

(22) Filed: Mar. 31, 2021

(51) Int. Cl. B60K 37/02; G06F 16/9536; H04L 12/58

(52) U.S. Cl. CPC B60K 37/02; G06F 16/9536; H04L 51/32; B60K 2370/193; B60K 2370/195; B60K 2370/165

(57) ABSTRACT

A vehicle multimedia system includes one or more displays configured to output information at a vehicle, and a processor in communication with the one or more displays. The processor is programmed to access a user's social networking website, communicate post information associated with the user's social networking website, utilize a filter associated with the post information, wherein the filter is configured to ignore post information in response to one or more settings associated with the filter, and output filtered post information at the one or more displays at the vehicle, wherein the post information includes at least text associated with the post information and user information associated with the post information.

### TECHNICAL FIELD

The present disclosure relates to a vehicle multimedia system. In particular, the disclosure may relate to a vehicle multimedia system linked to various social media servers and accounts.

### BACKGROUND

A vehicle multimedia system can connect to a user's mobile device, such as a cell phone, so that the user may control various aspects of the mobile device. Sophisticated vehicle multimedia systems allow a user to connect to a mobile device to make hands-free calls through the vehicle multimedia system so that a user is not distracted by the mobile device. Furthermore, it is common for a vehicle multimedia system to incorporate the mobile device's contact list so that a user of the vehicle multimedia system and the mobile device may easily locate a person who they want to call. Vehicle multimedia systems also employ navigation or GPS systems to locate and direct a user to a desired location. Social networking websites have become an everyday part of people's lives. Social networking websites include an option for a user to send a post (e.g., update a status) based on what the user is doing.

### SUMMARY

According to one embodiment, a computer-based method for sharing a user's activities within a vehicle with a social networking website is disclosed. The method includes accessing a personal electronic device capable of accessing a user's social networking website, communicating to a vehicle multimedia system housed in the vehicle, the vehicle multimedia system in communication with the personal electronic device, the vehicle multimedia system having a computer processing unit, communicating post information associated with the user's social networking website, utilizing a filter associated with the post information, wherein the filter is configured to ignore post information in response to one or more settings associated with the filter, and outputting filtered post information at one or more displays at the vehicle, wherein the post information includes at least text associated with the post information and user information associated with the post information.

According to a second embodiment, a vehicle multimedia system includes one or more displays configured to output information at a vehicle, and a processor in communication with the one or more displays. The processor is programmed to access a user's social networking website, communicate post information associated with the user's social networking website, utilize a filter associated with the post information, wherein the filter is configured to ignore post information in response to one or more settings associated with the filter, and output filtered post information at the one or more displays at the vehicle, wherein the post information includes at least text associated with the post information and user information associated with the post information.

According to a third embodiment, a vehicle computer system includes a processor in communication with one or more displays at the vehicle. The processor is programmed to access information from one or more of a user's social networking websites, communicate post information associated with the user's social networking websites, utilize a filter associated with the post information, wherein the filter is configured to output post information with a prioritization in response to one or more settings associated with the filter, and output filtered post information at the one or more displays at the vehicle, wherein the post information includes at least text associated.

### BRIEF DESCRIPTION OF THE DRAWINGS

FIG. 1 is a system overview of a vehicle computer system.

FIG. 2 is an illustrative flowchart 200 of a social media server in communication with a vehicle.

FIG. 3 is an illustrative flowchart 300 of a system-level flowchart utilizing a social media center according to one embodiment.

FIG. 4 is an example of a display of a vehicle outputting various social media feeds. In such an example, the display is a heads-up display (HUD).

FIG. 5 is an example table 500 of actions associated with the social media center.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The disclosure relates to a social media integration center that may be equipped in a vehicle to allow a driver to view feeds (e.g., posts or notifications) in a simple form while driving. The app may allow the driver to play or pause the feeds, change a speed of prompting the feeds, listen to the feeds via vehicle audios, and respond to the feeds (e.g. replay, post, like, or archive). The app may also allow the driver to mark the feeds as read or unread. In addition, the app may filter out or prioritize feeds that may contain driving related information such that the driver can make driving decisions upon viewing the feeds.

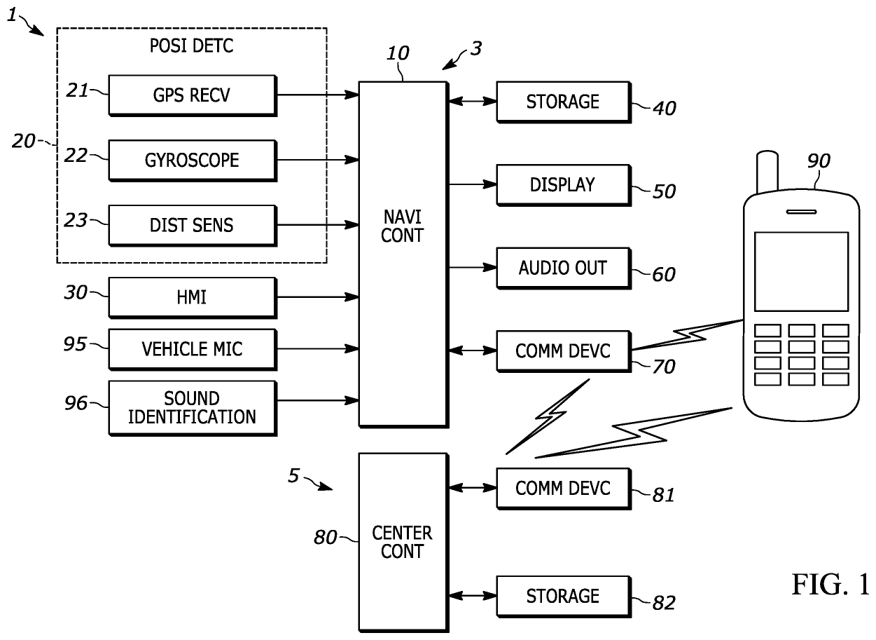

As shown in FIG. 1, a vehicle system 1 includes a navigation apparatus 3 and a data center 5. The navigation apparatus 3 may be equipped in a vehicle and may include a navigation controller (NAVI CONT) 10 or processor. The navigation apparatus may be a portable terminal, such as a smart phone having a navigation function, other than a device equipped to a vehicle. The navigation apparatus may also be an off-board server or system that processes directions and maneuvers off-board that are to be sent to the vehicle. The route may be calculated using a remote service place and pushed into the vehicle storage. The navigation could be played as audio messages or visual indications (e.g. icons). Local position detectors (either on-board or off-board) may be utilized to match car's position to the route info. The navigation controller 10 may include a microcomputer, which has a central processing unit (CPU), a read only memory (ROM), a random-access memory (RAM), an input/output (I/O) interface and a bus line for coupling the CPU, the ROM, the RAM and the I/O interface. The navigation controller 10 may include a position detector (POSI DETC) 20, a user interface or human machine interface (HMI) 30, a storage 40, a display screen (DISPLAY) 50, an audio output device (AUDIO OUT) 60, and a communication device (COMM DEVC) 70. The position detector 20 may detect a present position of the vehicle. The user interface 30 may be used for inputting a command from a user to the navigation apparatus 3 or vehicle system 1. The storage 40 may store map data. The display screen 50 may display a map and various information to the user. The audio output device 60 may output audio guidance and sounds to occupants of the vehicle. The communication device 70 of the navigation apparatus 3 may communicate with an off-board server 5 or data center 5. Furthermore, the communication device 70 (or another communication device, such as a wireless transceiver as a Bluetooth transceiver), may be utilized to communication with a mobile device 90, such as a mobile phone. The mobile device 90 may be utilized for handsfree communication or other capabilities based on interoperability with the vehicle system 1. The display 50 may include a heads up display (HUD) that is configured to output information on a windshield of the vehicle to allow for the driver to focus on the road while operating the interface.

The position detector 20 may receive signals transmitted from satellites for a global positioning system (GPS). The position detector 20 may include a GPS receiver (GPS RECV) 21, a gyroscope (DIST SENS) 22, and a distance sensor (DIST SENS) 23. The GPS receiver 21 may detect a position coordinate and an altitude of the present position of the vehicle. The gyroscope 22 outputs a detection signal corresponding to an angular velocity of a rotational motion applied to the vehicle. The distance sensor 23 outputs a traveling distance of the vehicle. The navigation controller 10 calculates the present position, a direction, and a velocity of the vehicle based on signals output from the GPS receiver 21, the gyroscope 22, and the distance sensor 23. Further, the present position may be calculated in various methods based on the output signal from the GPS receiver 21. For example, a single point positioning method or a relative positioning method may be used to calculate the present position of the vehicle.

The HMI 30 or user interface 30 includes a touch panel and may include mechanical key switches. The touch panel is integrally set with the display screen 50 on the display screen or located away from the display such as in front of an arm rest. The mechanical key switches are arranged around the display screen 50. When the navigation apparatus 3 provides a remote-control function, operation switches for the remote-control function are arranged in the HMI 30. The HMI 30 may also include a voice recognition system that utilizes voice prompts to operate various vehicle functions. The HMI 30 may also include a haptic device or similar device that allows a user to control and operate the system. The HMI 30 may also include a voice recognition system, remote touchpad, or utilize a stylus pen.

The storage 40, in which the applications and map data is stored, inputs various data included in the map data to the navigation controller 10. The various data includes road data, facility data, point-of-interest (POI) data, address book data, and guidance data. The road data is indicative of a road connection status, and includes node data, which indicates a predetermined position such as an intersection, and link data, which indicates a link that connects adjacent nodes. The facility data is indicative of a facility on the map. The guidance data is used for route guidance. Address book data may be utilized to store custom contacts, locations, and other information (e.g. home or work). POI data may be utilized to identify a POI'S location, contact information, category information, review (e.g. Zagat or Yelp) information, etc. Examples of a POI may be a McDonald's under the category of a fast-food restaurant; Starbuck's under coffee shop, a Holiday Inn under the category of hotel, etc. Other POI examples may include, hospitals, dealerships, police stations, cleaners, etc. POIs may be independent business or corporate businesses. The storage 40 may be configured to be rewritable in order to update various applications, software, operating system, and the user interface of the vehicle. For example, a hard disk drive (HDD) and a flash memory may be used as the storage 40.

The display screen 50 may be a color display apparatus having a display surface such as a liquid crystal display, or a heads-up display (HUD). The display screen 50 displays various display windows according to video signal transmitted from the navigation controller 10. Specifically, the display screen 50 displays a map image, a guidance route from a start point to a destination, a mark indicating the present position of the vehicle, and other guidance information. The display screen 50 may also be a touch screen interface that allows for a user to interact with an operating system, software, or other applications via interaction with the screen. The audio output device 60 may output audible prompts and various audio information to the user. With above-described configuration, the route guidance can be performed by displaying viewable information on the display screen 50 and outputting audible information with the audio output device 60.

The communication device 70 may communicate data with the “cloud,” for example, a data center 5. Specifically, the navigation apparatus 3 may be wirelessly coupled to a network via the communication device 70 so that the navigation apparatus 3 performs the data communication with the data center 5. The communication device 70 may be an embedded telematics module or may be a Bluetooth transceiver paired with mobile device 90 utilized to connect to remote servers or the “cloud.” The communication device 70 may be both a Bluetooth communication or another form of wireless (or wired) communication. The “cloud” may also be utilized to process voice recognition commands. Thus, the “cloud” may store a voice recognition engine and be utilized to communicate voice commands and associated responses with the vehicle.

The server 5, which is remote from the vehicle, mainly includes a data center controller (CENTER CONT) 80. Similar to the navigation controller 10, the data center controller 80 mainly includes a well-known microcomputer, which has a CPU, a ROM, a RAM, an input/output interface and a bus line for coupling the CPU, the ROM, the RAM and the I/O interface. The data center controller 80 includes a communication device (COMM DEVC) 81, a first storage (FIR STORAGE) 82. The communication device 81 of the data center 5 performs the data communication with the navigation apparatus 3. Specifically, the data center 5 is wirelessly coupled to the network via the communication device 81 so that the data center 5 performs the data communication with the navigation apparatus 3. The server may include information related to one or more social networking websites.

The system may be equipped with a vehicle mic 95 or sound identification device 96. The sound identification device 96 determines a probability that the sound data corresponds to a pre-defined sound based on the subset of temporal parameters. In the illustrative embodiment, the sound identification device 96 applies an algorithm (e.g. trained deep-neural-network or other machine learning network) to initiate a voice recognition session. In the illustrative embodiment, the algorithm takes a number of inputs corresponding to the number of temporal parameters. Each acoustic feature vector may include a number of features and temporal parameters that are determined for each acoustic feature. Of course, in other embodiments, the number of parameters may vary. The deep-neural-network algorithm of the illustrative sound identification device 96 may have previously been trained using machine learning in order to accurately determine if the sound data matches a pre-defined command. The deep-neural-network algorithm may employ a softmax layer, backpropagation, and cross-entropy optimization as part of the training. This training may include supplying samples of sounds that match the pre-defined sound and samples of sounds that do not match the pre-defined sound, such as sounds similar to expected background noise. For example, if the pre-defined sound is an infant crying, the algorithm may be provided with a number of samples of infants crying as well as sounds similar to expected background noise such as adult conversation, road traffic noise, and other vehicle sounds.

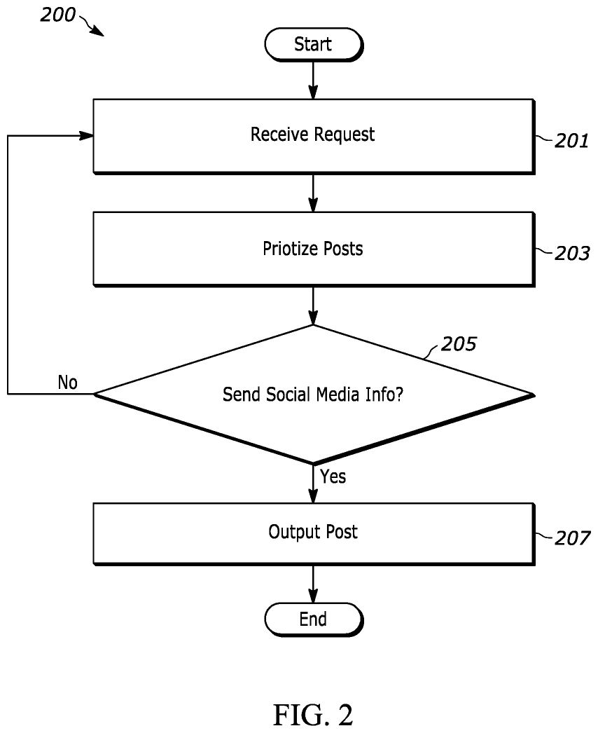

FIG. 2 illustrative flow chart 200 of a social media server in communication with a vehicle. At step 201, the server may receive a ping from the vehicle indicating a request for information. The information may include social media data, including accounting information, account photos, posts, login and security credentials (e.g., password and login name), photos, etc. The server may include an application program interface (API) to communicate with the social media website, or it may be at the social media website. In addition to receiving the request, the system may also receive vehicle data indicating vehicle environment or driving information to be utilized in deciding how to filter information. This may include filter settings to be applied as related to the various social media posts.

At decision 203, the system may prioritize certain posts. The server may receive information related to various settings related to the vehicle and determine how to prioritize the posts based on those settings. If there is no information to be sent related to social media, then the system may continue to wait to receive a ping for a request of information from the social media website at step 201. The system may utilize the settings to determine which information to send and which information to ignore. The information that is sent may be displayed at the vehicle, the information that is ignored may be hidden from being displayed at the vehicle.

At step 205, the system may determine whether to send the social media information or not. The server may filter out and decide what information to send based on a variety of factors associated with the vehicle environment and the social data associated with the driver. If the system decides to not send the information, the items may be hidden and not displayed at the vehicle. If the system decides to send the information, the items may be displayed at the vehicle. When the system does not want to send the post, it may continue to wait for a request to display the information at step 201.

At step 207, the server may send the social media information to the vehicle. The social media information may be filtered at the server, or it may be filtered at the vehicle. The social media information may include a time stamp indicating when to output the information and when to hide the information. The vehicle may decide how to display the social media information given the various settings. The method and rate at which information is sent may be further discussed below.

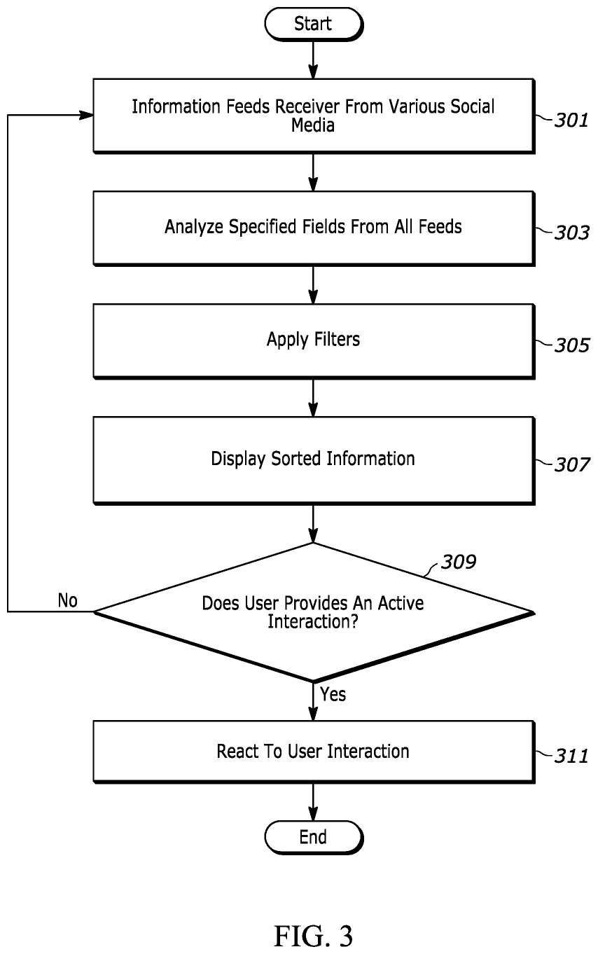

FIG. 3 is an illustrative flowchart 300 of a system-level flowchart utilizing a social media center according to one embodiment. At step 301, the system may receive an information feed from various social media channels. The system may be in communication with a remote server with access to various social media websites, networks, servers, etc. In one embodiment, the user may have to authorize the various social media channels. Thus, certain websites or social media platforms may be ignored. Additionally, the occupant of the vehicle may ignore certain social media users. The social networking website may allow a user to update their status, receive messages, photos, videos, notifications (e.g., Tweets, stories, Facebook status posts, etc.), and other information. Various social networking websites having social networking website status update capability may allow a user to manually update their status.

At step 303, the system may read specified fields from all feeds. Thus, the system at the vehicle may download the data and choose to present the interface of the social media feed in a certain user interface. The social media data may include a location of the post (e.g., where the user is located based on the post), the poster (e.g., the user who posted the social media post), a posting time, contents of the post, etc. The social media data may also include the media associated with the post (e.g., pictures, sound, video, etc.) or any other information.

At step 305, the system may apply filters to the information feed from the social media accounts. The system may apply the filters based on a user priority setting to set the information of the feeds in order of importance as determined by the user. This may include a favorite list (e.g., identifying favorite users, subject matter, etc.), proximity (e.g., based on nearest location to the vehicle or further location to the vehicle), social media accounts (e.g., prioritize Twitter over Facebook), recent posts (e.g., post within last minute, hour, or day), etc. For example, the user may prioritize posts for users near the vehicle, thus the tweets may be relevant to traffic information. The user may be able to edit the filters in a dedicated application or setting at the vehicle, mobile device, website, etc.

At step 307, the system may be able to output the displayed information as sorted. The system may utilize the social media data, combined with the settings and filters, to present the user the interface at the display of the vehicle. The system may be configured to apply a default action based on the message type. For example, the system may be configured to always “like” the post of a preset contact of the group. As such, the system may send instructions or information to the social media website indicating a “like.” In another example, the system may automatically play a video for a default threshold time (e.g., 10 seconds) that may be adjusted by a user setting. Thus, the social media may be supported to standard format on a user interface or display screen, regardless of the social media platform or website the information is retrieved from. Thus, the integration may allow for the system to determine priorities, determine how to link a vehicle route to social media (e.g., search radius for notifications within a vicinity of the vehicle), and determine which messages should be highlighted.

At decision 309, the system may determine whether the user provides an active interaction. This may include interactions with different types of social media feeds (e.g., for traffic related posts, reroute request information can be sent to the map application; and for videos, who can select play options and information searching for food post can search ingredients, etc.) If no active interaction is provided, the system may simply revert back to receiving information feeds from the various social media channels at step 301. The vehicle system may determine a vehicle environment and cognitive load of the user to determine if it is appropriate to allow the user to conduct an active interaction. The allowed interaction may be different for different types of social media feeds. For example, for traffic related posts, a reroute request can be sent to a navigation map application. In another example, for videos, the user can select play options and information searching. In yet another example, for a food post, the system can allow searching for ingredients.

At step 311, if the system determines that the user may provide an active interaction, the system may react to the user interaction. This may include playing and pausing the feed, speeding up or speeding down the control of the posts coming into the interface at the vehicle, allowing the user to hear the message in an audio format (e.g., if the driver has their eyes closed or focused on driving, audio play of the text may be automatically turned on). The system may also allow the user to respond to the feed via a voice recognition system or touch screen interface with actions, such as a response to the post, replay, new post, like, archive, etc.

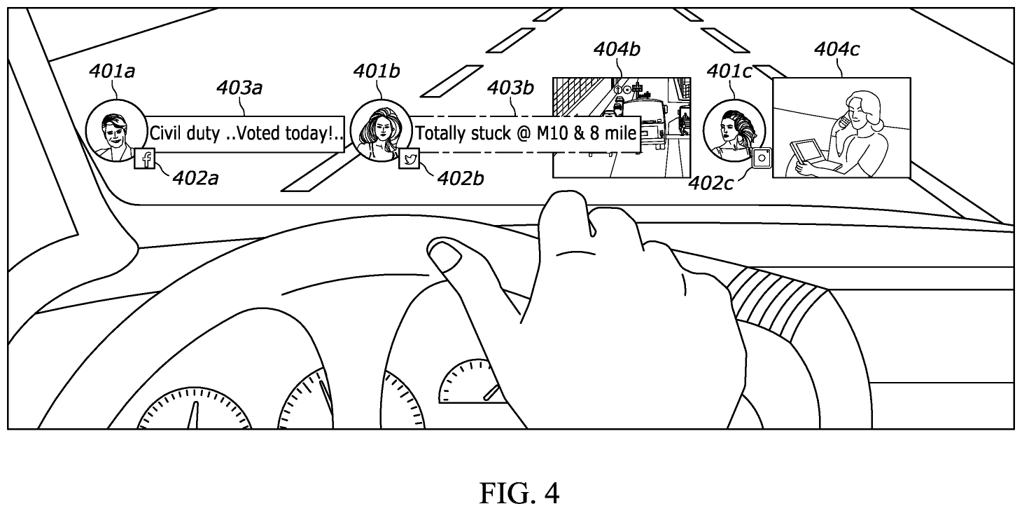

FIG. 4 is an example of a display of a vehicle outputting various social media feeds. In such an example, the display is a heads-up display (HUD). The HUD may display certain posts and feeds that it deems relevant to the driver at a certain moment. The posts may be selected based on the user posting the message, the subject or content, or the relevancy to the vehicle environment. The system may output a symbol 402a, 402b, 402c associated with the social network website, a username associated photo 401a, 401b, 401c, and the text 403a, 403b associated with the post, or a video, picture, or other media 404c associated with the post. For example, one post states “Totally stuck @ M10 & 8 Mile” may be deemed relevant as it is part of the driver's commute or near a vicinity of a home, work, or another POI of the driver. In another example, a post may be displayed that states “Civil Duty . . . Voted today.” Any text or icons may be displayed; however, the text may be associated with the post related to the social media. As mentioned above, the posts may be filtered or delivered at a certain speed based on user settings or the vehicle environment.

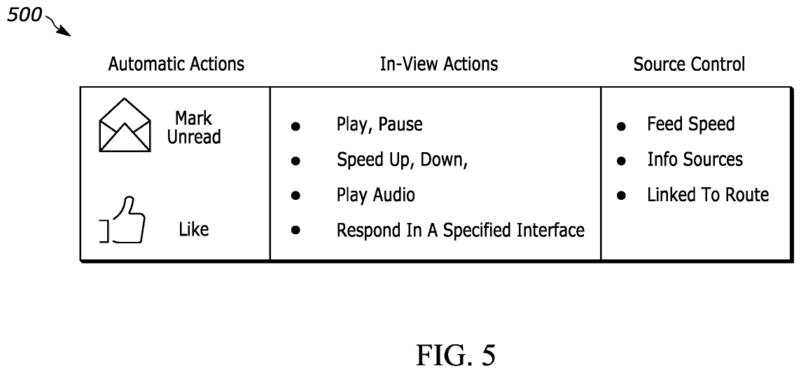

FIG. 5 is an example table 500 of actions associated with the social media center. The table may be associated with a database, look-up table, or algorithm that may be utilized to determine how to handle various system actions from social media feeds. One action may include an automatic action associated with the social media feed. Such an action may include a “mark unread” action that will identify the message as unread. Another action may include a “like” action, that will send a “like” notification to a social media post.

The system may include in-view actions as well. The in-view actions may be responses or other actions to a message that can be done while the message/post is being viewed or played. The in-view actions may allow various functions or actions that may occur related to the posts or media associated with the posts (e.g., videos or pictures). For example, the video may be played or paused, as well as rewound or fast forward. The system may also play audio. The system may also allow to respond in a specified interface. Responding in a specified interface may include responding with emoji, responding with GIFs, direct replies, react to the message or post, etc.

The system may also include a source control as well. The source control may allow options or settings as related to the feeds that are input at the vehicle. For example, feed speed may be a setting that allows the speed of social media posts to come in upon closing one of the posts at a certain refresh rate.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-based method for sharing a user's activities within a vehicle with a social networking website, the method comprising:
accessing a personal electronic device capable of accessing a user's social networking website;
communicating to a vehicle multimedia system housed in the vehicle, the vehicle multimedia system in communication with the personal electronic device, the vehicle multimedia system having a computer processing unit;
communicating post information associated with the user's social networking website;
utilizing a filter associated with the post information, wherein the filter is configured to ignore post information in response to one or more settings associated with the filter; and
outputting filtered post information at one or more displays at the vehicle, wherein the post information includes at least text associated with the post information and user information associated with the post information.

2. The computer-based method of claim 1, wherein the method further includes hiding a first social media post at the display of the vehicle after a time threshold expires.

3. The computer-based method of claim 1, wherein the method further includes outputting a second social media post at the display at a feed speed set by a user of the vehicle, wherein the second social media post is output in response to hiding the first social media post.

4. The computer-based method of claim 1, wherein the method includes output filtered post information in response to one or more vehicle environment factors.

5. The computer-based method of claim 1, wherein the one or more settings include a favorite list associated with ranking either one or more social media websites and one or more social media users.

6. The computer-based method of claim 1, wherein the one or more settings includes filtering associated with position information in closest proximity to the vehicle.

7. The computer-based method of claim 1, wherein the display is a heads-up display (HUD).

8. The computer-based method of claim 1, wherein outputting filtered post information includes outputting two or more filtered posts.

9. A vehicle multimedia system, comprising:
one or more displays configured to output information at a vehicle;
a processor in communication with the one or more displays, wherein the processor is programmed to:
access information from a user's social networking website;
communicate post information associated with the user's social networking website;
utilize a filter associated with the post information, wherein the filter is configured to ignore post information in response to one or more settings associated with the filter; and
output filtered post information at the one or more displays at the vehicle, wherein the post information includes at least text associated with the post information and user information associated with the post information.

10. The vehicle multimedia system of claim 9, wherein the processor is further programmed to access a personal electronic device capable of accessing the user's social networking website.

11. The vehicle multimedia system of claim 9, wherein the filter post information includes a first social media post, wherein the processor is further programmed to hide the first social media post at the one or more displays of the vehicle after a time threshold expires.

12. The vehicle multimedia system of claim 9, wherein the processor is further programmed to output a second social media post at the one or more displays at a feed speed set by a user of the vehicle, wherein the second social media post is output in response to hiding the social post.

13. The vehicle multimedia system of claim 9, wherein the processor is programmed to access the user's social networking website utilizing a mobile device in communication with the vehicle multimedia system.

14. The vehicle multimedia system of claim 9, wherein the processor is further programmed to send instructions to like the post associated with a preset contact.

15. The vehicle multimedia system of claim 9, wherein the display is a heads up display (HUD) configured to output information at a windshield of the vehicle.

16. The vehicle multimedia system of claim 9, wherein the processor is further programmed to play a threshold period of video associated with the post information, wherein the threshold period of video is associated with a user setting.

17. A vehicle computer system, comprising:
a processor in communication with one or more displays at the vehicle, wherein the processor is programmed to:
access information from one or more of a user's social networking websites;
communicate post information associated with the user's social networking websites;
utilize a filter associated with the post information, wherein the filter is configured to output post information with a prioritization in response to one or more settings associated with the filter; and
output filtered post information at the one or more displays at the vehicle, wherein the post information includes at least text associated.

18. The vehicle computer system of claim 17, wherein the post information includes user information associated with the post information, including a profile picture associated with the user information.

19. The vehicle computer system of claim 17, wherein the processor is further programmed to hide a first social media post at the display of the vehicle after a time threshold expires.

20. The vehicle computer system of claim 19, wherein the processor is further programmed to output a second social media post at the display at a feed speed set by a user of the vehicle, wherein the second social media post is output in response to hiding the first social media post.
